(19) United States
(12) Patent Application Publication
(10) Pub. No.: US 2004/0183425 A1
(43) Pub. Date: Sep. 23, 2004

(54) Color-separating electrode structure and apparatus for manufacturing same

(76) Inventors: Shinichi Ooe, Tokyo (JP); Haruo Watanuki, Tokyo (JP); Takeshi Tsukasaki, Tokyo (JP); Yoshio Mizumoto, Tokyo (JP)

Correspondence Address: BIRCH STEWART KOLASCH & BIRCH, PO BOX 747, FALLS CHURCH, VA, 22040-0747, US

(21) Appl. No.: 10/718,807

(22) Filed: Nov. 24, 2003

(30) Foreign Application Priority Data
Mar. 19, 2003 (JP) 2003-074761

(51) Int. Cl. H01J 29/80; H01J 9/12; H01J 9/236

(52) U.S. Cl. 313/407; 313/402; 445/47; 445/36; 445/37

(57) ABSTRACT

The color-separating electrode structure for use in a color CRT includes a color-separating electrode body which is substantially rectangular in form and fixed in a tensioned condition to a frame made by a sheet metal bending or flexing process. The frame includes two supporting parts opposed to each other, each of the supporting parts having a flexed portion that extends in parallel to an upper edge and a lower edge of the color-separating electrode body and has a predetermined curvature. The color-separating electrode body is welded to the frame at contact portions thereof each of which is in contact with corresponding one of the flexed portions of the supporting parts.

### BACKGROUND OF THE INVENTION

1. Field of the Invention

The present invention relates to a color-separating electrode structure for use in a color CRT, the structure including a color-separating electrode body which comprises a thin metal plate stretched on a frame and having a number of electron beam passing holes formed therein (generally referred to as a shadow mask or an aperture grille).

2. Description of the Background Art

Generally, the color-separating electrode structure is manufactured by welding upper and lower edges of a color-separating electrode body to side members opposed to each other of a four-sided frame by use of roller electrodes. Recently, the color-separating electrode body is becoming thinner and the width of the side member (referred to as “supporting member” hereinafter) of the frame is becoming narrower in an attempt to reduce the weight and the manufacturing cost of the CRT. Narrowing the width of the supporting member of the frame makes the width of a contact portion between the color-separating electrode body and the supporting member narrower. Consequently, poor weld may occur unless accuracy in controlling position of the roller electrodes and manufacturing tolerances of the frame are improved accordingly. However, both improving accuracy in controlling position of the roller electrodes and improving manufacturing tolerances of the frame invite a substantial increase of the manufacturing cost.

On that account, there is a method of manufacturing the color-separating electrode structure characterized by setting outer edges of the supporting members as welding paths, and causing the roller electrodes to travel along the outer edges of the supporting members in order to prevent occurrence of poor weld without promoting accuracy in position control of the support member or manufacturing tolerances of the frame from normal levels, thereby addressing the demand of reduction of the weight and the manufacturing cost of the color CRT. For example, refer to Japanese Patent Application Laid-Open No. 09-147759 ([0015] to [0017], FIG. 1 to FIG. 3), or Japanese Patent Application Laid-Open No. 2000-67748 ([0021] to [0035], FIG. 1, FIG. 4, FIG. 6).

However, it is being proposed to use a hollow frame made by a sheet metal bending or flexing process instead of the conventional solid frame having an L-shaped cross section made by a drawing process attempting further reduction of the weight and the manufacturing cost of the color CRT. In such a hollow frame, its surface for supporting the color-separating electrode body is not flat but curved. That is, the color-separating electrode body is supported by a curved surface of a sheet metal flexed so as to have a certain curvature. In such a frame, the supporting surface thereof is an edgeless curved surface, so the method disclosed in Japanese Patent Application Laid-Open No. 09-147759, or Japanese Patent Application Laid-Open No. 2000-67748 cannot be used.

Furthermore, in the case of using such a hollow frame, there is a problem that the color-separating electrode body may deform since the width of the contact portion between the color-separating electrode body and the frame is very narrow and the roller electrode therefore deviates from its welding path easily. There is also another problem that poor weld may occur since the roller electrode easily contacts some part of the color-separating electrode body other than a specific part intended to be contacted and welded, causing the welding current to be diverted.

### SUMMARY OF THE INVENTION

The present invention has been made in light of the above-described problems with an object of enabling welding the color-separating electrode body to the hollow frame made by a sheet metal bending or flexing process with reliability, thereby achieving further reduction of the weight and the manufacturing cost of the color CRT.

To achieve this object, the present invention provides a color-separating electrode structure for use in a color CRT, the structure including a color-separating electrode body which is substantially rectangular in form and fixed in a tensioned condition to a frame made by a sheet metal bending or flexing process, wherein

the frame includes two supporting parts opposed to each other, each of the supporting parts having a flexed portion that extends in parallel to an upper edge and a lower edge of the color-separating electrode body and has a predetermined curvature,

the color-separating electrode body being welded to the frame at contact portions thereof each of which is in contact with corresponding one of the flexed portions of the supporting parts.

### BRIEF DESCRIPTION OF THE DRAWINGS

In the accompanying drawings:

FIG. 1 is an explanatory view for explaining a method and an apparatus for manufacturing a color-separating electrode structure for use in a color CRT of a first embodiment according to the invention;

FIG. 2 shows an A-A cross section of the color-separating electrode structure shown in FIG. 1;

FIG. 3 shows a proper positional relationship among a frame, a color-separating electrode body, and a roller electrode in the first embodiment;

FIGS. 4(a) and 4(b) show improper positional relationships among the frame, the color-separating electrode body, and the roller electrode in the first embodiment;

FIGS. 5(a) and 5(b) show cross-sectional profiles of roller electrodes of an apparatus for manufacturing a color-separating electrode structure of a second embodiment according to the invention; and

FIG. 6 shows a shape of a roller electrode of an apparatus for manufacturing a color-separating electrode structure of a third embodiment according to the invention.

### DESCRIPTION OF THE PREFERRED EMBODIMENTS

Embodiment 1.

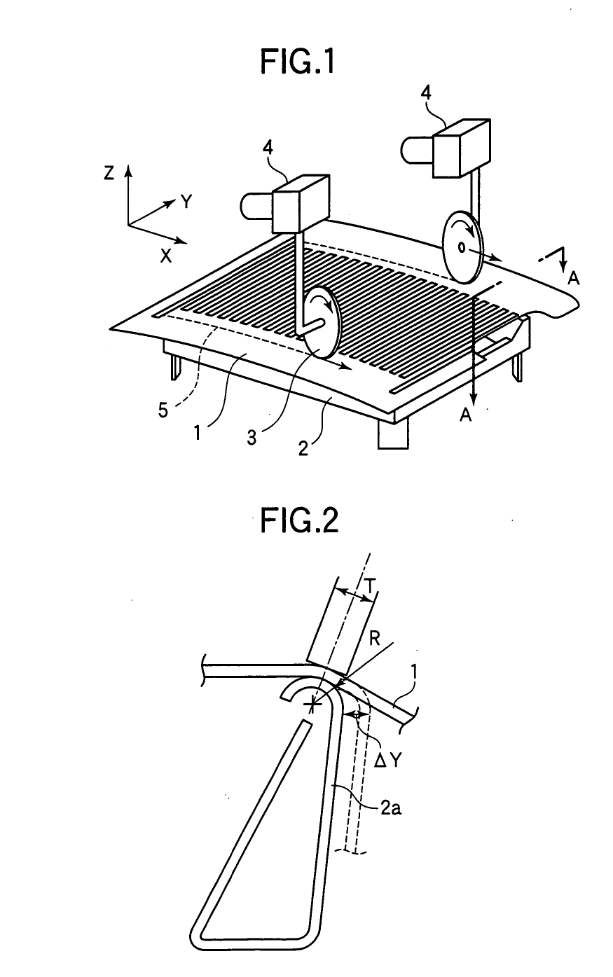

FIG. 1 is a schematic view of a color-separating electrode structure for use in a color CRT during a welding process of the manufacturing method according to the invention. In FIG. 1, X represents a traveling direction of roller electrodes 3 or an arranging direction of an array of slits of a color-separating electrode body 1, Y represents a direction which is orthogonal to the direction X and in which each of the slits extends, and Z represents a direction orthogonal to the direction X and the direction Y. The above definition of the directions X, Y, Z applies to the following explanations referring to FIG. 1 and other figs. These directions X, Y, Z are referred to as X-direction, Y-direction, Z-direction respectively hereinafter.

As shown in FIG. 1, the color-separating electrode structure is assembled by welding the color-separating electrode body 1 to a frame 2 by use of the roller electrodes 3. The color-separating electrode body 1 is made by etching a thin metal plate to form a number of slits or holes therein. For reducing the weight and the manufacturing cost, the frame 2 is made by a sheet metal bending or flexing process. Accordingly the frame 2 has a hollow structure, and the supporting parts thereof support the color-separating electrode body 1 at curved surfaces. Each of the supporting parts has a cross-sectional profile with a certain curvature (3 mm for example).

The width of the roller electrode 3 should be large enough to prevent the roller electrode 3 from deviating from a welding path 5 and dropping off the frame 2 taking account of precision of a not illustrated profiling device for sensing the profile of the frame 2 applied with pressure and deformed, and precision of a not illustrated sensor for sensing a position of the roller electrode 3 during travel. Accordingly, in this embodiment, as shown in FIG. 2 which is an A-A cross section of the color-separating electrode structure shown in FIG. 1, the width T of the roller electrode 3 is determined to have a value satisfying the following mathematical expression. T >ΔY+R, where ΔY is a maximum amount of deformation of the frame 2 when it is pressed in the Y-direction (to be more specific, a maximum amount of deformation of a supporting part 2a of the frame 2).

Furthermore, in this embodiment, the roller electrode 3 is tilted by a certain angle with respect to the Z-direction, or with respect to the X-Y plane. Although the roller electrode 3 is tilted automatically by a motor-driven tilting device 4 in this embodiment, it is permissible to tile the roller electrode 3 manually when mounting the roller electrode 3.

The process in which the color-separating electrode 1 is welded to the frame 2 is explained. First, the frame 2 is deformed inward by a certain amount by use of a not illustrated frame-deforming device such as a turn buckle. Then, the color-separating electrode body 1 held under slight tensions in the X-direction and the Y-direction is brought into intimate contact with the frame 2 deformed by application of the pressure. Bringing the color-separating electrode body 1 into intimate contact with the frame 2 can be done by setting the deformed frame 2 in a certain position followed by moving down the color-separating electrode body 1 in the Z-direction until it comes in contact with the frame 2, or alternatively, by setting the color-separating electrode body 1 under the tension in the Y-direction in a certain position followed by moving up the deformed frame 2 in the Z-direction until it comes in contact with the color-separating electrode body 1.

Next, the roller electrodes 3 are caused to travel along the contact portions between the frame 2 and the color-separating electrode body 1 extending in the direction of the length (X-direction) of the supporting parts 2a of the frame 2. By passing a current from one of the roller electrodes 3 to the other intermittently while they travel, the color-separating electrode body 1 is welded to the supporting parts 2a. The roller electrode 3 is coupled to a not illustrated pressing device comprising a cylinder, a spring and so forth so that the color-separating electrode body 1 is pressed against the supporting part 2a of the frame 2 while the roller electrode 3 travels. The roller electrode 3 travels leaning outward with respect to the Z-direction (X-Y plane) by a certain angle through the action of the tilting device 4.

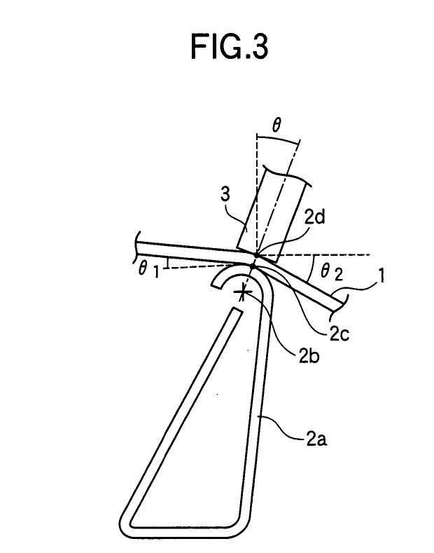

As shown in FIG. 3, the inclination angle θ of the roller electrode 3 is determined to satisfy the following mathematical expression θ1<θ<θ2 where θ1 is an angle which the color-separating electrode body 1 forms with the X-Y plane inside the frame 2, and θ2 is an angle which the color-separating electrode body 1 forms with the X-Y plane outside the frame 2. The angles θ1 and θ2 are determined in accordance with stiffness of the color-separating electrode body 1 and the amount of force with which the color-separating electrode body 1 is pressed against the frame 2.

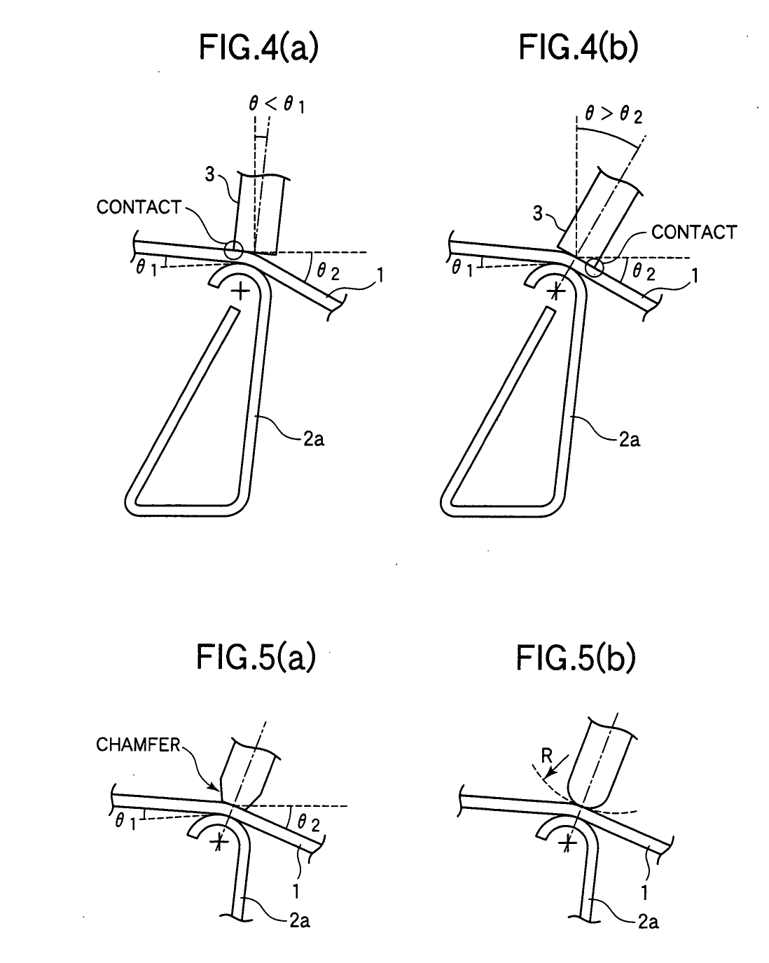

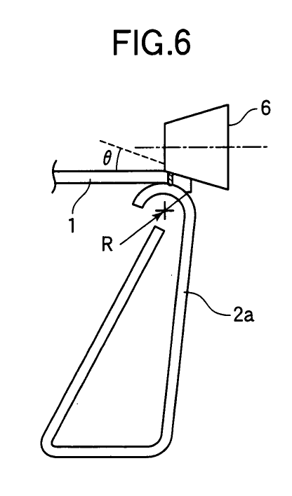

For instance, the inclination angle θ of the roller electrode 3 is set between 5 degrees and 7 degrees when θ1 is 3 degrees and θ2 is 10 degrees. If the inclination angle θ of the roller electrode 3 is smaller than θ1, the roller electrode 3 may contact the color-separating electrode body 1 inside the frame 2 as shown in FIG. 4(a), while if the inclination angle θ of the roller electrode 3 is larger than θ2, the roller electrode 3 may contact the color-separating electrode body 1 outside the frame 2 as shown in FIG. 4(b). If the roller electrode 3 contacts any part of the color-separating electrode body 1 other than the specific part to be contacted and welded, some of the welding current is diverted, causing the weld at this part to be defective. When the pressure applied to the frame 2 is released after completion of the welding process, the color-separating electrode body 1 is applied with a certain tension by springback action of the frame 2.

In this embodiment, since an adequate clearance is created between the part not to be welded of the color-separating electrode body 1 and the welding face of the roller electrode 3 by setting the angles θ, θ1, θ2 to satisfy the relationship of θ1<θ<θ2 so that a flexural center 2b of the supporting part 2a, a center 2c of the contact portion, and a point at which the roller electrode 3 contacts the color-separating electrode body 1 are aligned as shown in FIG. 3, the color-separating electrode body 1 can be welded to the supporting part 2a at the top of the curved surface thereof with high reliability.

In addition, since the roller electrode 3 is caused to travel leaning outward with respect to the Z-direction (X-Y plane), the roller electrode 3 does not shift to the inside of the frame 2 from its welding path. Even if the roller electrode 3 shifts to the outside of the frame 2 from its welding path, distortion resulting from the deviation from the welding path can be prevented form occurring to the color-separating electrode body 1, since the supporting parts 2a of the frame 2 shift outward and stretch the color-separating electrode body 1 when the turnbuckle is removed.

Embodiment 2.

Although the roller electrode 3 is rectangular in cross section in the embodiment 1, if the limb of the roller electrode 3 is chamfered as shown in FIG. 5(a) or the welding face of the roller electrode 3 is rounded to have a relatively large curvature R as shown in FIG. 5(b), more adequate clearance can be created between the welding face of the roller electrode 3 and the part not to be welded of the color-separating electrode body 1, and accordingly the diversion of the welding current due to the contact between the roller electrode 3 and the part not to be welded of the color-separating electrode body 1 can be prevented with greater reliability. The explanation of the welding process in the embodiment 2 is omitted, since the embodiment 1 and the embodiment 2 are the same except for the cross-sectional profile of the roller electrode 3.

Embodiment 3.

Although the roller electrode 3 is disc-shaped in the embodiment 1, if a different roller electrode 6 in the shape of a truncated cone with a cone angle of θ is used instead of the roller electrode 3, the device for tilting the roller electrode can be eliminated and accordingly the manufacturing apparatus can be simplified. The explanation of the welding process of the embodiment 3 is omitted, since the embodiment 1 and the embodiment 3 are the same except for the shape of the roller electrode 3.

The above explained preferred embodiments are exemplary of the invention of the present application which is described solely by the claims appended below. It should be understood that modifications of the preferred embodiments may be made as would occur to one of skill in the art.

What is claimed is:

1. A color-separating electrode structure for use in a color CRT, the structure including a color-separating electrode body which is substantially rectangular in form and fixed in a tensioned condition to a frame made by a sheet metal bending or flexing process, wherein
the frame includes two supporting parts opposed to each other, each of the supporting parts having a flexed portion that extends in parallel to an upper edge and a lower edge of the color-separating electrode body and has a predetermined curvature,
the color-separating electrode body being welded to the frame at contact portions thereof each of which is in contact with corresponding one of the flexed portions of the supporting parts.

2. An apparatus for manufacturing the color-separating electrode structure described in claim 1, the apparatus comprising:
a device for welding the color-separating electrode body to the frame along the contact portions by having two welding electrodes rotate to travel along their respective welding paths on a front face of the color-separating electrode body;
wherein each of the welding electrodes is tilted with respect to a plane including the contact portions by a predetermined angle in order that a welding face of each of the welding electrodes is substantially perpendicular to a straight line passing through a flexural center of corresponding one of the flexed portions and corresponding one of the contact portions.

3. An apparatus for manufacturing the color-separating electrode structure according to claim 2, in which the predetermined angle is larger than an angle which the color-separating electrode body forms with the plane inside the frame and is smaller than an angle which the color-separating electrode body forms with the plane outside the frame.

4. An apparatus for manufacturing the color-separating electrode structure according to claim 2, in which an edge of each of the welding electrodes is chamfered.

5. An apparatus for manufacturing the color-separating electrode structure according to claim 3, in which an edge of each of the welding electrodes is chamfered.

6. An apparatus for manufacturing the color-separating electrode structure according to claim 2, in which a welding face of each of the welding electrodes is rounded to have a predetermined curvature.

7. An apparatus for manufacturing the color-separating electrode structure according to claim 3, in which a welding face of each of the welding electrodes is rounded to have a predetermined curvature.

8. An apparatus for manufacturing the color-separating electrode structure described in claim 1, the apparatus comprising:
a device for welding the color-separating electrode body to the frame along the contact portions by having two welding electrodes rotate to travel along their respective welding paths on a front face of the color-separating electrode body;
wherein each of the welding electrodes is in the shape of a truncated cone in order that a welding face of each of the welding electrodes in contact with the color-separating electrode body is substantially perpendicular to a straight line passing through a flexural center of corresponding one of the flexed portions and corresponding one of the contact portions.

9. An apparatus for manufacturing the color-separating electrode structure according to claim 8, in which a cone angle of the welding electrode is larger than an angle which the color-separating electrode body forms with the plane inside the frame and is smaller than an angle which the color-separating electrode body forms with the plane outside the frame.
